(19) United States
(12) Patent Application Publication
(10) Pub. No.: US 2026/0260065 A1
(43) Pub. Date: Sep. 3, 2026

(54) Speculative Decoding using Expanded Token Matching

(71) Applicant: Microsoft Technology Licensing, LLC, Redmond, WA (US)

(72) Inventors: Sayan Dev PATHAK, Kirkland, WA (US); Harini KESAVAMOORTHY, Bellevue, WA (US); Christopher Hakan BASOGLU, Everett, WA (US); Ayush VIKRAM, Seattle, WA (US); Amy Parag SHAH, Bothell, WA (US); Rakesh KELKAR, Bellevue, WA (US)

(73) Assignee: Microsoft Technology Licensing, LLC, Redmond, WA (US)

(21) Appl. No.: 19/067,886

(22) Filed: Mar. 1, 2025

(51) Int. Cl. G06F 40/284; G06F 16/3329; G06F 16/34

(52) U.S. Cl. CPC G06F 40/284; G06F 16/33295; G06F 16/345

(57) ABSTRACT

A speculative decoding technique generates tokens of a response using a verifying model and drafting model. In operation, the verifying model receives a set of draft tokens produced by the drafting model. The verifying model then verifies whether the draft tokens are correct by comparing probability information generated by the verifying model with probability information generated by the drafting model. The verifying model then determines whether any draft token that is rejected by the verifying is otherwise accepted based on a specified matching criterion. The above process is repeated one or more times to generate the response. The technique has the overall effect of expanding a number of draft tokens that are accepted, thereby reducing use of resources and deceasing latency.

### BACKGROUND

Machine-trained models have proven capable of generating accurate responses in a variety of applications. However, many models achieve their success by incorporating a relatively large number of machine-trained parameters. For instance, some large language models include hundreds of billions of parameters. Increasing the number of parameters increases the amount of memory and processor resources required to store and run the machine-trained models. Increasing the number of parameters also increases the latency of operations performed by the machine-trained models. One factor that contributes to the increase in latency is the time required to transfer parameters to and from memory.

### SUMMARY

A speculative decoding technique is described herein for generating tokens of a response using the cooperative interaction between a first machine-trained model (referred to as the verifying model) and a second machine-trained model (referred to as the drafting model). The response refers to information output by the speculative decoding technique, e.g., corresponding to a sequence of text tokens and/or other type(s) of tokens that answer an input query. In operation, the verifying model receives a set of draft tokens generated by the drafting model. The verifying model then verifies correctness of the draft tokens by comparing probability information generated by the first machine-trained model with probability information generated by the second machine-trained model. This operation is referred to herein as a probability-based verification. The verifying model then determines whether any draft token that has been rejected by the probability-based verification is otherwise accepted based on a specified matching criterion. This operation is referred to herein as a matching-based evaluation. The verifying model accepts any draft token that passes the probability-based verification, and any draft token that fails the probability-based verification but passes the matching-based evaluation. The verifying model then provides the accepted subset of draft tokens to the drafting model for use by the drafting model in generating a next set of draft tokens for a next iteration. By applying the matching-based evaluation, the verifying model extends or relaxes the evaluation condition used by the probability-based verification.

The above-summarized technology can be implemented by various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a speculative decoding system for generating tokens using a drafting model and a verifying model.

FIG. 2 shows an example of the operation of the verifying model.

FIG. 3 shows an implementation of the speculative decoding system of FIG. 1 that uses a single execution platform.

FIG. 4 shows an implementation of the speculative decoding system of FIG. 1 that includes a client device and a server-based evaluating system.

FIG. 5 shows a process that describes one manner of operation of the verifying model of FIG. 1.

FIG. 6 shows an example of the process of FIG. 5.

FIGS. 7-9 show three implementations of the drafting model of FIG. 1.

FIG. 10 shows an implementation of the verifying model of FIG. 1.

FIG. 11 shows an implementation of a matching sub-component, which is a component of the verifying model of FIG. 10.

FIG. 12 shows an example of an interface produced by the verifying model of FIG. 10 for collecting configuration information.

FIG. 13 shows an illustrative language model for implementing the drafting model and/or the verifying model of FIG. 1.

FIG. 14 is a flowchart that provides an overview of one manner of operation of the speculative decoding system of FIG. 1 from the perspective of a verifying model.

FIG. 15 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview

A speculative decoding system is a type of system that uses the cooperative interaction between two machine-trained models to generate the tokens of a response. The response refers the information generated by the speculative decoding system, e.g., corresponding to a sequence of text tokens (and/or other types of tokens) that answer an input query. The two models are referred to herein as a drafting model and a verifying model, The drafting model is smaller than the verifying model. For example, the drafting model uses fewer parameters than the verifying model. As a consequence, a computing device requires less memory and processor resources to run the drafting model compared to the verifying model. Further, because the drafting model involves the execution of fewer computations in generating tokens compared to the verifying model, it has lower latency compared to the verifying model. However, the drafting model on average has lower quality compared to the verifying model. More specifically, the drafting model will generate draft tokens having varying quality. For those circumstances in which a token-generating task does not involve complex considerations, the drafting model will produce accurate draft tokens. For more complex token-generating tasks, the drafting model will produce lower quality draft tokens, potentially including inaccurate draft tokens. An accurate or correct token is a token that agrees with a ground-truth correct token. An inaccurate or incorrect token is a token that differs from the ground-truth correct token.

A speculative decoding system generates a response by repeating the following operations over plural iterations. In a first operation, the speculative decoding system uses the drafting model to generate a batch of draft tokens, such as five draft tokens. In a second operation, the speculative decoding system uses the verifying model to verify whether each draft token in the batch is correct. Upon identifying a particular draft token as incorrect, the verifying model generates a correct token to replace the particular draft token. The verifying model also rejects any draft token in the batch that follows the particular draft token. In a next iteration, the drafting model generates another set of draft tokens, starting with the last-accepted draft token of the previous batch. For example, upon determining that the third draft token in a set of five draft tokens is incorrect, the verifying model rejects the third draft token, the fourth draft token, and the fifth draft token, and produces a correct version of the rejected third draft token.

Speculative decoding systems improve latency and reduce the use of processor and memory resources insofar as the drafting model generates at least some of the tokens of the final response. This is because it is more efficient to generate tokens using the drafting model compared to the verifying model. The verifying operation itself can be quickly performed in a single pass (e.g., by evaluating all of the draft tokens in parallel), and therefore does not adversely affect latency. In a worst case scenario, the verifying model rejects every draft token in a batch; here, the latency of the speculative decoding system will be no worse than using the larger verifying model to autoregressively generate all of the tokens of a response.

Existing speculative decoding systems use a single probability-based veification to determine whether each draft token is correct. That is, for a particular draft token under consideration, a speculative decoding system compares first probability information generated by the drafting model with second probability information generated by the verifying model. Each instance of probability information describes the likelihood that a draft token is correct. In some applications, the verifying model will accept a draft token if the second probability information is equal to or greater than the first probability information. If this condition is not met, the verifying model will perform additional probability-based verification to determine whether to accept or reject the draft token. This kind of token processing is referred to herein as a probability-based verification. It depends on a comparison of the probability information generated by the Softmax layers of the drafting model and the verifying model. In some examples, the probability information produced by the verifying model for a draft token under consideration determines what token is considered as the ground-truth correct token.

A speculative decoding system is described herein that improves upon the above type of system by expanding and extending the conditions under which the verifying model will accept a draft token as being correct. More specifically, the speculative decoding system performs a matching-based evaluation for any draft token that has failed the probability-based verification. The speculative decoding system will accept a draft token if: a) the draft token passes the probability-based verification; or b) the draft token fails the probability-based verification but passes the matching-based evaluation. The speculative decoding system will reject the draft token if: a) it fails the probability-based verification and the matching-based evaluation; b) or if it is preceded by more than a prescribed number of draft tokens that have passed the matching-based evaluation.

In some implementations, the matching-based evaluation includes determining whether the characteristics of a draft token under consideration are semantically and/or syntactically relevant to current context information. For example, in a text summarization application, the matching-based evaluation determines whether the semantic content of a draft token under consideration matches the key points in a passage being summarized. The context information generally refers to any information that has a bearing on the appropriateness of a draft token under consideration. The scope and content of the context information varies for different respective applications.

The matching-based evaluation has the overall effect of expanding the number of draft tokens that the verifying model accepts, compared to the use of the probability-based verification by itself. The increased acceptance of draft tokens, in turn, decreases the use of memory and processor resources by the speculative decoding system. This is because, as explained above, the drafting model is smaller than the verifying model, and therefore, by increasing the number of accepted draft tokens, the speculative decoding system increases its reliance on the more latency-efficient and resource-efficient drafting model in generating a response. The matching-based evaluation specifically reduces latency beyond that achieved using the probability-based verification because the increased reliance on the drafting model has the overall effect of reducing the number of transactions involving access to memory.

For some batches, the decrease in latency can be significant. For example, as will be explained in greater detail below, FIG. 2 describes a batch of tokens for which the probability-based verification, operating by itself, would accept none of the draft tokens, whereas the probability-based verification operating in cooperation with the matching-based evaluation would accept all of the draft tokens. Here, the speculative decoding system will derive the benefit of using the more efficient drafting model to generate all of the draft tokens in the batch.

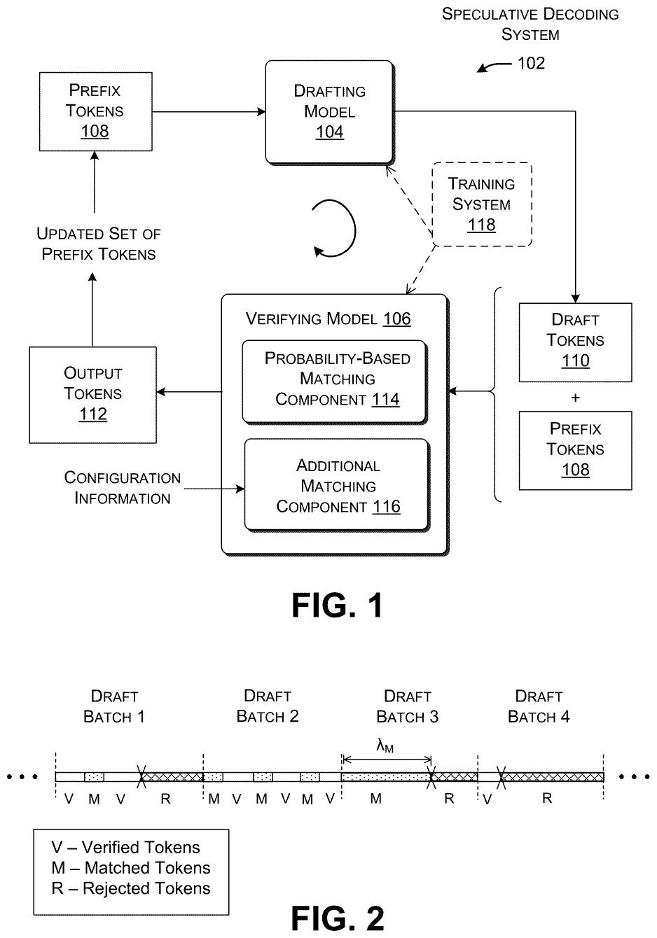

With the above introduction, FIG. 1 will now be explained in detail below. FIG. 1 shows a speculative decoding system 102 that generates tokens of a response based on the cooperative contributions of a drafting model 104 and verifying model 106. A “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. Although the speculative decoding system 102 is described principally below in the context of the processing of text tokens, other implementations apply the speculative decoding system 102 to other kinds and combinations of media items (including text, images, videos, audio items, etc.).

The drafting model 104 and the verifying model 106 are two respective machine-trained models of different sizes. The size of a machine-trained model is based on a total number of machine-trained parameters used by a model. More specifically, the drafting model 104 includes fewer parameters than the verifying model 106. As such, the drafting model 104 requires less memory to store its parameters compared to the verifying model 106. The drafting model 104 also requires less time to transfer its parameters to and from memory compared to the verifying model 106 (because there are less parameters to transfer). In other words, the drafting model 104 exhibits lower latency compared to the verifying model 106. However, on average, the drafting model 104 produces less accurate tokens compared to the verifying model 106 due to its use of fewer parameters than the verifying model 106. More specifically, some tokens are more difficult to predict than others. The drafting model 106 can be expected to produce generally accurate results for less complex token-generating tasks and less accurate results for more complex token-generating tasks. For example, generating the token “cat” after the phrase “the dog chased the” is a less complex token-generating task, while generating the token “dog” after the “the man chased his” is more complex, since this token-generating task requires a more nuanced evaluation of the context than the first token-generating task.

In some examples, the drafting model 104 and verifying model 106 are two models having different sizes from a same family of language models. For example, the LLaMA family of models is currently available in sizes of 8B, 70B, and 405B parameters. The drafting model 104 uses functionality provided by an 8B LLλMA model (for example) while the verifying model 106 uses functionality provided by the 405B LLaMA model (for example). General background information on the LLaMA language model is available at in Touvron, et al., “LLaMA: Open and Efficient Foundation Language Models,” arXiv, arXiv:2302.13971v1 [cs.CL], Feb. 27, 2023, 27 pages. In other implementations, the drafting model 104 and the verifying model 106 have different respective architectures (e.g., corresponding to different families), but are trained to produce consistent probability distributions. Note that, while the drafting model 104 and the verifying model 106 may use the functionality provided by publicly available language models, they also include components that are not included in these publicly available language models.

The speculative decoding system 102 produces tokens in a series of iterations, denoted in FIG. 1 by a looping arrow. In one such operation, the drafting model 104 maps a set of prefix (context) tokens 108 to a set of draft tokens 110. The prefix tokens collectively constitute a prompt fed to the drafting model 104. The prefix tokens 108, for instance, include tokens that have been previously generated by the speculative decoding system 102. For some applications, the prefix tokens 108 also include auxiliary information extracted from a source item. For example, in a particular case, an application uses the speculative decoding system 102 to produce a summary of a passage of text. The auxiliary information in this case includes tokens of the passage of text. Initially, the prefix tokens 108 include tokens that represent a query input to the speculative decoding system 102 and any auxiliary information referenced by the query.

The verifying model 106 maps the draft tokens 110 and the prefix tokens 108 to evaluation results that identify the correctness of the draft tokens. As an outcome, the verifying model 106 provides output tokens 112 that include zero, one, or more tokens that are accepted as being correct, together with one generated token produced by the verifying model 106. For example, in a particular case, the verifying model 106 determines that the first two of five draft tokens are accepted, and the third is rejected. The output tokens 110 in this case will include the first two draft tokens and a corrected counterpart of the third token produced by the verifying model 106. The criteria by which a draft token is accepted as correct or incorrect will be clarified below.

As explained above, the task of evaluating a batch of draft tokens requires fewer resources than autoregressively generating the tokens. For example, the verifying model 106 maps the entire batch tokens into output logits in a single pass, and performs its evaluation based on these output logits. The verifying model 106 therefore has a resource utilization cost that is similar to the generation of a single token.

The speculative decoding system 102 next updates the prefix tokens 108 to include the output tokens 112. The speculative decoding system 102 then repeats the above-described operations. The speculative decoding system 102 will terminate its processing when the drafting model 104 generates a stop token that is verified as correct by the verifying model 106. The speculative decoding system 102 is “speculative” in the sense that it uses draft tokens that are lower-confidence or speculative counterparts of the tokens of an ideal response, in which tokens generated by the verifying model 106 constitute a proxy for the ideal response. The speculative decoding system 102 outputs a response that includes the tokens produced in the above iterative manner, which, in some cases, constitutes an answer to an input query.

The verifying model 106 performs a two-part evaluation on some of the draft tokens in the set of draft tokens 110. In a probability-based verification, a probability-based matching component 114 assesses the accuracy of each draft token based on first probability information generated by the drafting model 104 and second probability information generated by the verifying model 106. Accuracy here is a measure of whether a particular draft token agrees with a ground-truth correct token. That is, an accurate or correct draft token is a token that agrees with the ground-truth correct token, while an inaccurate or incorrect token is a token that differs from the ground-truth token. As will be more fully explained in Section C, the probability information generated by the verifying model 106 reveals whether the draft tokens is accurate or inaccurate. More specifically, in a particular case, the drafting model 104 assigns a first probability q to a draft token under consideration. This token probability is one probability in a distribution of token probabilities for different tokens in a vocabulary of tokens. Further, in this example, the verifying model 106 assigns a second probability p to the draft token under consideration, obtained from its own probability distribution. In some examples, the probability-based matching component 114 accepts the draft token if the second probability (computed by the verifying model 106) for this token generally matches or is greater than the first probability (computed by the drafting model 104), which, in turn, indicates that the verifying model 106 would have selected the same drafting token as the drafting model 104. Otherwise, the probability-based matching component 114 rejects the draft token under consideration. Again, Section C provides additional details regarding one implementation of the probability-based matching component 114, including its decision logic.

In a matching-based evaluation, an additional matching component 116 determines whether a particular draft token that has failed the probability-based verification is otherwise accepted because it satisfies a specified matching criterion. Matching criterion generally refers to any basis, depending on any combination of specified matching factor(s), by which two items are compared. In some implementations, the additional matching component 116 performs the matching-based evaluation by extracting a first attribute from context information, extracting a second attribute from the draft token under consideration, and determining whether the first attribute matches the second attribute. In many cases, the first attribute and the second attribute describe semantic characteristics of the context information and the draft token, respectively. For example, the attributes may correspond to distributed vectors that capture semantic information.

Illustrative examples of the operation of the additional matching component 116 are provided below, with respect to different applications. Section C provides additional details regarding how each application is implemented. In the following, a draft token is considered accepted if it passes the probability-based verification applied by the probability matching component 114, or the draft token fails the probability-based verification but passes the matching-based evaluation applied by the additional matching component 116.

Text Summarization. In a first example, a text summarizing application uses the speculative decoding system 102 to summarize a passage of text. Here, the context information includes, at least in part, the passage of text or a portion thereof. Alternatively, or in addition, the context information includes a token that is identified by the verifying model 106 as being correct for the draft token under consideration, which may either agree with or differ from the draft token under consideration. The additional matching component 116 identifies one or more key points expressed by the context information. The additional matching component 116 generates an evaluation result that indicates that the draft token under consideration is accepted if it matches one of the key points of the context information, even though the draft token has failed the probability-based verification. As will be described in Section C, in some implementations, the additional matching component 116 is capable of performing its matching-based evaluation by mapping the draft token under consideration to a first distributed vector, mapping the context information to a second distributed vector, and then comparing the first distributed vector with the second distributed vector.

Automated Agent. In a second example, a chatbot application uses the speculative decoding system 102 to generate a response to a question or statement by a user. Here, for a particular draft token under consideration, the context information includes, at least in part, a token that is identified by the verifying model 106 as being correct, which may either agree with or differ from the particular draft token under consideration. The context information also includes at least a portion of a preceding dialogue (if any) between the automated agent and the user. The additional matching component 116 identifies an intent of the verifying model's token and a logical flow of the dialogue. The additional matching component 116 generates an evaluation result that indicates that the draft token is accepted if it shares the same intent as the verifying model's token and is consistent with the logical flow of the dialogue, as reflected in the portion of the dialogue information captured by the context information. Again, Section C describes a framework for performing this type of computation.

Creative Writing. In a third example, a writing assistance application uses the speculative decoding system 102 to create a document, such as a poem or a short story. Here, the context information includes, at least in part, the token that is identified by the verifying model 106 as being correct for the draft token under consideration. The context information also includes at least a portion of any text that has been generated thus far. The additional matching component 116 identifies the theme and style of the context information, and accepts the draft token if it shares the same theme and style of the context information.

Paraphrasing. In a fourth example, a paraphrasing application uses the speculative decoding system 102 to paraphrase a passage of text. Here, the context information includes, at least in part, the passage of text or a portion thereof. In addition, or alternatively, the context information includes a token that is identified by the verifying model 106 as being correct for the draft token under consideration. The additional matching component 116 identifies a meaning of the passage of text. The additional matching component 116 generates an output result that indicates that the draft token under consideration is accepted if it is consistent with the meaning of the context information.

Data Augmentation. In a fifth example, a data augmentation application uses the speculative decoding system 102 to generate examples that are consistent with a set of existing training examples, but include permissible variations from the set of existing training examples. Here, the context information includes, at least in part, a particular existing training example under consideration, and/or the token identified by the verifying model 106. The additional matching component 116 identifies a syntactical structure and semantic characteristics of context information. The additional matching component 116 generates an output result that indicates that the draft token under consideration is accepted if it shares the same syntactical structure as the existing training example and it's semantic content is a prescribed deviation from the semantic content of the existing training example. This is an example in which two attributes that are considered to match are purposely chosen so that they are not equivalent.

A training system 118 assesses the divergence between ground-truth responses and model-generated responses produced by the speculative decoding system 102, given a corpus of training examples. The training system 118 uses any loss function to measure divergence, such as KL divergence or cross entropy. The training system 118 then updates the parameters of the speculative decoding system 102 based on the divergence. More specifically, in some implementations, the training system 118 updates the parameters of the verifying model 106 while holding the parameters of drafting model 104 frozen (that is, constant). In other examples, the training system 118 updates the parameters of the verifying model 106 and the drafting model 104

FIG. 2 shows an example of evaluations produced by the verifying model 106 for four batches of draft tokens produced by the drafting model 104. The symbol “V” indicates that the verifying model 106 has produced probability-based verification results that indicate that a draft token under consideration has passed the probability-based verification performed by the probability-based matching component 114. The symbol “M” indicates that the verifying model 106 has indicated that a draft token has failed the probability-based verification but has passed the matching-based evaluation performed by the additional matching component 116. The symbol “R” indicates that the verifying model 106 has generated evaluation results that indicate that a draft token has failed both the probability-based verification and the matching-based evaluation, or indicating the draft token has failed the probability-based verification and is preceded by a prescribed number of draft tokens have been assigned the “M” status.

With respect to the last-mentioned basis for rejection, for the third batch, the verifying model 106 eventually rejects a token regardless of whether it passes the matching-based evaluation based on a finding that the number of preceding tokens that have passed the matching-based evaluation (M) is equal to a prescribed number given by a token span threshold parameter λ_{M}. For example, λ_{M} in this particular case is three, and the verifying model 106 has determined that the fourth draft token has failed the probability-based verification. The verifying model 106 will immediately reject the fourth draft token without performing the matching-based evaluation because adding another matched token (M) would exceed the token span threshold λ_{M}. This behavior reduces the risk that the semantic content of the draft tokens strays too far from a counterpart correct output identified by the verifying model 106.

Note that, by expanding the universe of accepted tokens to include matched draft tokens (M), the speculative decoding system 102 increases its use of draft tokens produced by the drafting model 104. For example, consider the second batch of draft tokens that interleaves verified draft tokens (V) with matched draft tokens (M). Here, the verifying model 106 accepts all draft tokens in the batch. Without the matching-based evaluation, the verifying model 106 would have accepted none of the draft tokens because it would have rejected the first non-verified draft token and all draft tokens to follow.

The increased acceptance of draft tokens reduces the use of resources by the speculative decoding system 102, compared to the case in which the probability-based matching component 114 is applied by itself. It also reduces the latency in which the speculative decoding system 102 produces its complete response, compared to the case in which the probability-based matching component 114 is applied by itself. Again, this is because the drafting model 104 uses fewer parameters than the verifying model 106, and therefore memory-based operations performed by the drafting model 104 are less resource intensive and faster than operations performed by the verifying model 106.

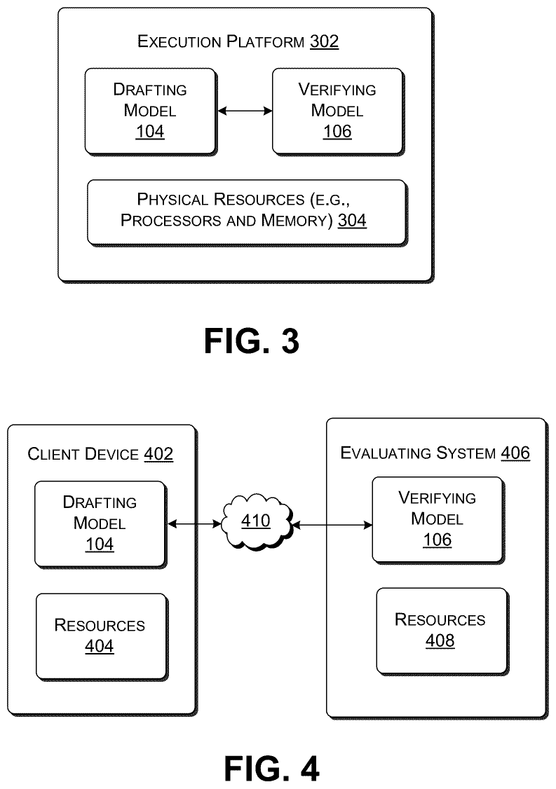

FIG. 3 shows a single execution platform 302 having physical resources 304 for implementing both the drafting model 104 and the verifying operation. For example, the execution platform 302 is a server-based system 102. A user or other entity interacts with the server-based system 102 using a client device of any type via any type of network connection (e.g., the Internet). In another implementations, the execution platform 302 represents an individual client device or other local system.

In the example of FIG. 4, a client device 402 having resources 404 implements the drafting model 104, while a separate evaluating system 406 having resources 408 implements the verifying model 106. For example, the evaluating system 406 is a server-based system that is accessible to the client device 402 via a computer network 410 of any kind (such as the Internet). Alternatively, the evaluating system 406 is a separate system that is local with respect to the client device 402.

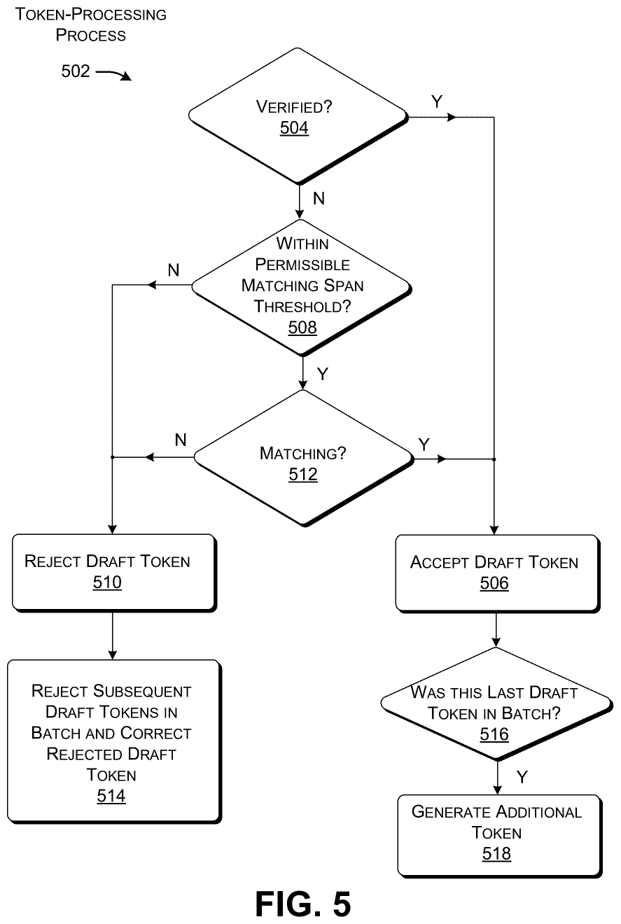

FIG. 5 shows a process 502 that explains one manner of operation of the verifying model 106. In block 504, the verifying model 106 determines whether the draft token passes the probability-based verification as administered by the probability-based component 114. If so, in block 506, the verifying model 106 designates the draft token as accepted. If block 504 is answered in the negative (N), in block 508, the verifying model 106 determines whether the draft token is preceded by a series of matched tokens (M) (as previously assessed by the additional matching component 116) equal to the number given by the token span threshold parameter λ_{M}. If so, in block 510, the verifying model 106 designates the draft token as rejected without actually performing the matching-based evaluation. If block 508 is answered in the negative (N), in block 512, the verifying model 106 determines whether the draft token passes the matching-based evaluation performed by the additional matching component 116. If so, the verifying model 106 designates the draft token (in block 506) as accepted. If not, the verifying model 106 designates the draft token as rejected (in block 510).

For the case in which the draft token is rejected (in block 510), in block 514, the speculative decoding system 102 rejects any draft tokens that follow the rejected token in the batch. The verifying model 106 also uses its existing probability information to identify a replacement for the draft token that has been rejected in block 510.

Alternatively, the draft token is accepted (in block 506). In block 516, the speculative decoding system 102 determines whether the draft token is the last draft token in the batch. If so, in block 518, the verifying model 106 uses its probability information to identify one extra token. Note that although the process 502 generates one new token in blocks 514 and 518, the verifying model 106 performs its verifying operations and generation operations in a single pass, e.g., using the logits produced by the verifying model's language model based on the entire set of draft tokens which are submitted to the language model at the same time.

Other implementations include one or more variations to the operations of the process 502 of FIG. 5. For example, in block 512, the additional matching component 116 generates an evaluation result that indicates whether a draft token is accepted based, at least in part, on a consideration of a counterpart of the draft token identified by the verifying model 106 (which may be considered as the correct or ideal token). This type of processing focuses on a single draft token. In other implementations, the probability-based matching component 116 generates an evaluation result that identifies each individual draft token in a batch that satisfies the probability-based verification. For each consecutive group of non-verified tokens equal to or less than the token span threshold parameter λ_{M}, the additional matching component 118 generates an evaluation result that indicates whether the group as a whole satisfies the specified matching criterion. If this is true, then the additional mapping component 118 identifies the entire group of non-verified draft tokens as accepted (M), even though any single draft token might not pass the matching-based evaluation when considered by itself. In other words, neighboring draft tokens in a group of draft tokens and their ideal counterparts provide context that is useful in determining whether to accept or reject the draft tokens in the group. For this reason, any reference below to evaluation operations performed on a single draft token should be construed as encompassing the example in which additional draft tokens and their ideal counterparts are also considered as added context. In some examples, the structure of context information itself defines the size of a group. For example, the additional matching component 116 can perform group analysis based on the draft tokens that make up a sentence.

In another variation, the verifying model 106 is capable of performing the matching-based evaluation on some or all of the batch of draft tokens before, or in parallel with, performing the probability-based verification. Accordingly, any description of the matching-based evaluation as following the probability-based verification should be interpreted to encompass the case in which these two tests are performed in the opposite order or in parallel. In other words, the order in which the tests are described does not necessarily imply that they are performed in that order.

In another variation, the verifying model 104 generates an output result that indicates whether a span of matched tokens (M) exceeds the token span threshold parameter λ_{M} based on a consideration of the matched tokens (M) in a current window combined with the matched tokens (M) in a previous window or plural previously windows, where a “window” refers to a span defined by a batch of draft tokens. For example, consider the example in which the last two draft tokens in a first batch are assigned the matching status (M), and the first three draft tokens in the next batch are assigned the matching status (M), the verifying model 104 will evaluate this combined grouping of matched tokens against the token span threshold parameter λ_{M}.

In another variation, the verifying model 104 uses a machine-trained model of any kind to determine whether a span of matched tokens (M) exceeds an accepted length. Such a machine-trained model 102 maps all of the context information and the draft token under consideration to an output decision.

Other implementations embody yet other variations, in addition to those specified above. Further, any implementation are capable of combining two or more of the variations specified above.

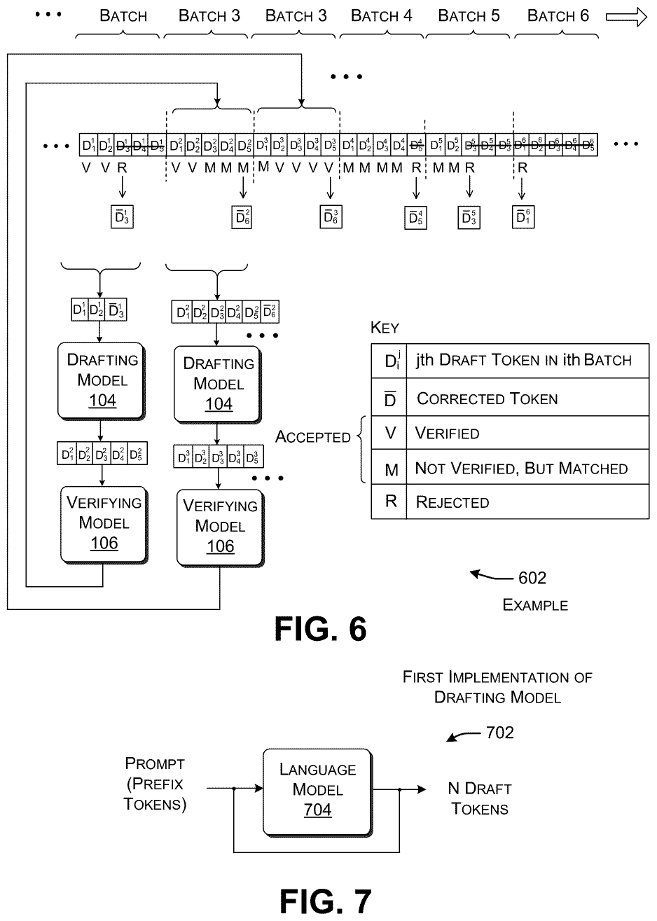

FIG. 6 shows an example of the process 502 of FIG. 5 over six batches of draft tokens. In this example, there are five draft tokens in each batch. In other implementations, a batch includes fewer or more than five draft tokens. In other implementations, the speculative decoding system 102 dynamically sets the number of draft tokens in a batch based on or more factors. For example, the speculative decoding system 102 creates a batch of draft tokens for each sentence or each program statement that it generates.

Consider the first batch of draft tokens. The verifying model 106 indicates that the first two draft tokens

$$( {D}_{1}^{1} , {D}_{2}^{1} )$$

pass the probability-based verification, as indicated by the symbol “V” beneath these two draft tokens. The verifying model 106 rejects the third draft token

$${\overline{D}}_{1}^{3}$$

because it fails both the probability-based verification and the matching-based evaluation, as designed by the symbol “R”. The verifying model 106 identifies a replacement

$$( {D}_{1}^{1} , {D}_{2}^{1} , {\overline{D}}_{1}^{3} ) ,$$

for the rejected third draft token. The speculative decoding system 102 next instructs the drafting model 104 to generate a second batch of five draft tokens based on the accepted and generated tokens from the first batch

$$( {D}_{1}^{2} , {D}_{2}^{2} )$$

together with other prefix tokens.

In the next iteration, the verifying model 106 indicates that the first two tokens of the second batch

$$( {D}_{3}^{2} , {D}_{4}^{2} , {D}_{5}^{2} )$$

pass the probability-based verification, and that the remaining three tokens

$${\overline{D}}_{6}^{2} ,$$

fail the probability-based verification but pass the matching-based evaluation, and therefore have the status of matched (M). In this example, the verifying model 106 uses its probability information to identify one additional token

$${D}_{3}^{1}$$

which is added to the set of accepted tokens that are fed to the drafting model 104 in a next iteration.

The above processing operations are repeated for remaining batches of draft tokens. Note that the verifying model 106 produces evaluation results that indicate that the number of matched tokens (M) in the fourth batch equals the number specified by the token span threshold λ_{M} parameter. This causes the verifying model 106 to immediately reject the fifth draft token

$$( {D}_{5}^{4} )$$

in this batch upon determining that it fails the probability-based verification, regardless of whether it would pass the matching-based evaluation. Further note that the verifying model 106 rejects all of the draft tokens in the sixth batch. In this case, the only token from the sixth batch that will subsequently be passed to drafting model 104 includes a token

$$( {\overline{D}}_{1}^{6} )$$

identified by the verifying model 106 as a replacement for the rejected first token in the batch

$$( {D}_{1}^{6} ) .$$

### B. The Drafting Model

FIGS. 7-9 show three implementations of the drafting model 104 of FIG. 1. In FIG. 7, a drafting model 702 uses a language model 704 to autoregressively produce the draft tokens of each batch, given a prompt that provides prefix tokens. Autoregressive means that the language model 704 produces the draft tokens over plural passes. At the end of each pass, the language model 704 appends a drafted token to the end of a sequence of tokens to be fed to the language model 704 in the next pass. The language model 704 of this example may represent a publicly available language model. While the language model 704 operates autoregressively, this operation can be performed quickly and with low resource requirements because the drafting model 702 includes a relatively small number of parameters.

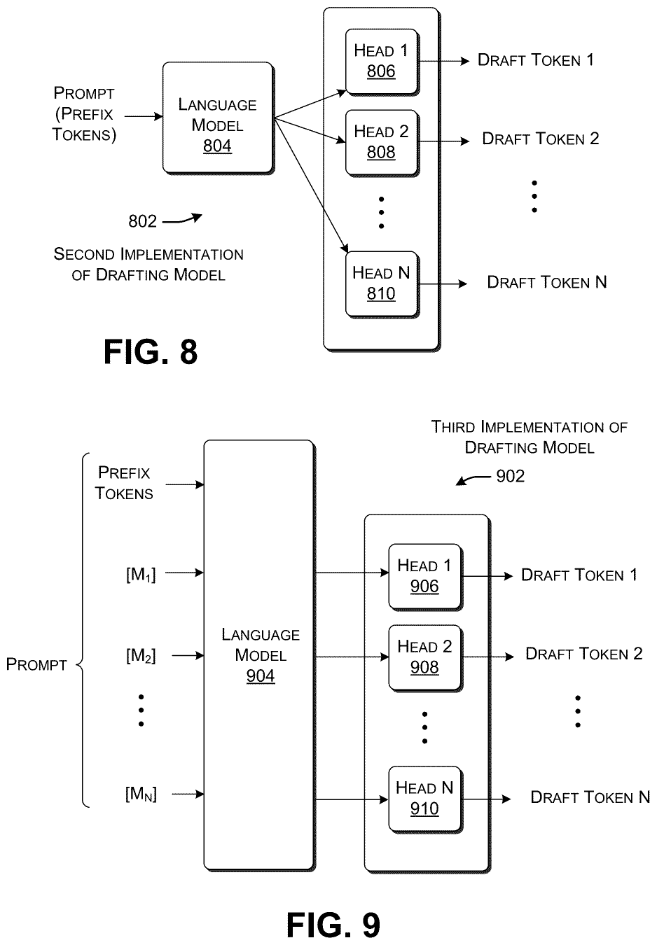

In FIG. 8, a non-autoregressive drafting model 802 includes a language model 804 that maps a prompt to output embedding information. A series of heads (806, 808, . . . , 810) map the output embedding information to different respective draft tokens of a batch in parallel. For example, each head is implemented by a fully-connected feed-forward neural network.

In FIG. 9, a non-autoregressive drafting model 902 again includes a language model 904 and a series of head (906, 908, . . . , 910). In this example, however, the language model 904 receives prefix tokens and a series mask tokens (M₁, M₂, . . . , M_{N}). The mask tokens include instances of dummy information (e.g., which map to predefined special token ID codes) that serve as placeholders. The language model 904 maps this information into a series of head-specific instances of output embedding information in parallel. The series of heads (906, 908, . . . , 910) map the respective instances of output embedding information to different respective draft tokens of a batch in parallel.

The above three examples are illustrative. Other implementations make use of a drafting model having a different architecture and/or different manner of operation than the above three examples.

### C. The Verifying Model

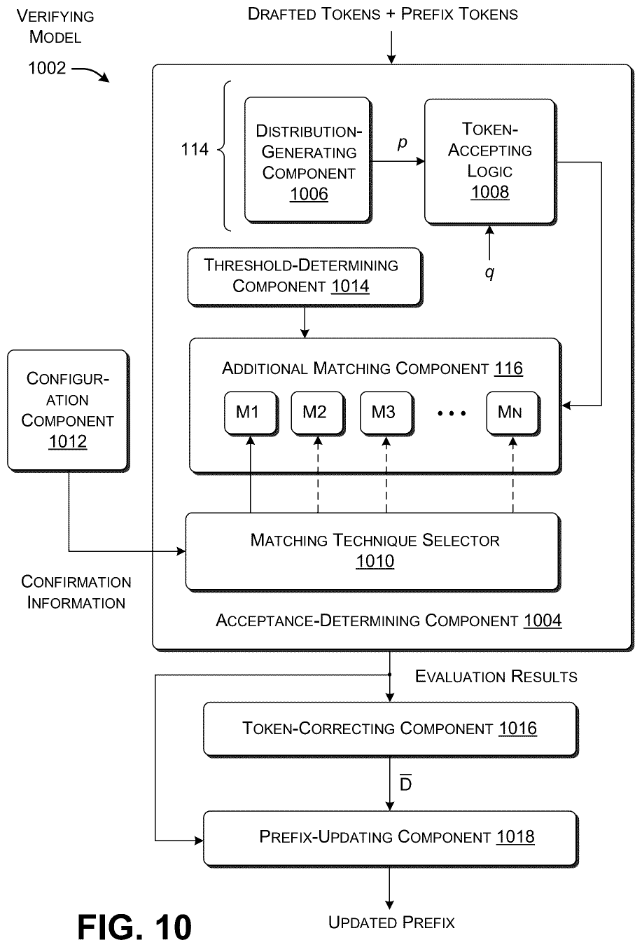

FIG. 10 shows one implementation of a verifying model 1002, corresponding to the verifying model 106 of FIG. 1. An acceptance-determining component 1004 determines whether to accept each draft token in a set of draft batch tokens. The acceptance-determining component 1004 includes the above-described probability-based matching component 114 for performing the probability-based verification, and the additional matching component 116 for performing the matching-based evaluation.

Referring first to the probability-based matching component 114, a distribution-generating component 1006 maps the sequence of draft tokens into probability distributions in a single pass. For each token position, a distribution identifies the probabilities associated with different candidate tokens. A token probability p represents the probability in the distribution that corresponds to a draft token under consideration, for example, the word “apple.” The drafting model 104 has produced a counterpart distribution for this token position. A token probability q corresponds to the probability in drafting model's distribution for the draft token (“apple”), e.g., which is produced by the drafting model 104 by sampling from its distribution.

Token-accepting logic 1008 determines whether to accept each draft token by comparing the probability q with the probability p. For example, consider the case in which the verifying model's probability distribution confirms a draft token chosen by the drafting model 104 with equal or higher confidence than the drafting model 104. In this circumstance, the token-accepting logic 1008 accepts the draft token chosen by the drafting model 104. The token-accepting logic 1008 handles the alternative case (in which the verifying model 1002 identifies another token than the draft token as the most probable) in different ways. In a greedy approach, the token-accepting logic 1008 rejects the draft token without further evaluation. In a sample-based approach, the token-accepting logic 1008 rejects or accepts the draft token by randomly selecting between these two options in a manner that is biased by some function of the probabilities p and q. For example, in some implementations, the probability of rejection is given by the function is 1−p/q.

The additional matching component 116 includes plural selectable matching sub-components (M1, M2, . . . , Mn) for performing matching in different respective ways for different respective applications. A matching technique selector 1010 selects one or more of these matching sub-components based on application-specific configuration information provided by a configuration component 1012. Generally, each matching sub-component extracts one or more attributes from context information and one or more attributes from a draft token under consideration. The matching sub-component generates an evaluation result that indicates that the draft token is accepted if the attribute(s) extracted from the context information match the attribute(s) extracted from the draft token under consideration. As previously noted, other implementations of the matching sub-component consider plural consecutive non-verified draft tokens when determining the acceptability of any draft token in this group, meaning that an evaluation need not be focused on an individual draft token in a batch.

A threshold-determining component 1012 determines the token span threshold parameter λ_{M} in a dynamic manner based on or more factors or based on a configuration setting specified in the configuration information. With respect the dynamic manner operation, in one implementation, the threshold-determining component 1014 dynamically adjusts the token span threshold parameter based on consideration of the levels of uncertainty associated the draft tokens identified as accepted by the additional matching component 116. For example, the threshold-determining component 1014 will decrease the token span threshold as the collective uncertainty in the group of accepted tokens grows. Alternatively, or in addition, the threshold-determining component adjusts the token span threshold based on the predicted length of a sentence or program statement being generated. The threshold-determining-component 1014 is implemented using any type of logic, such as rule-based logic and/or a machine-trained model. The machine-trained model maps contextual information regarding a set of draft tokens under consideration and/or other contextual factors to an output that specifies how the token span threshold parameter λ_{M} should be adjusted.

In some implementations, the distribution-generating component 1006 is implemented by a language model and the remaining components of the acceptance-determining component 1004 are implemented by add-on modules that operate on output logits produced by the language model. In other implementations, a language model is trained to perform all (or plural) of the functions of the components of the acceptance-determining component 1004.

A token-generating component 1016 relies on the probability information produced by the verifying model 1002 to produce a counterpart token to replace the first draft token that has been rejected (if any) in the batch of draft tokens. In a greedy approach, the token-generating component 1016 chooses the token having the highest confidence, as computed by the verifying model 1002 based on its probability distribution. In another approach, the token-generating component 1016 predicts the counterpart token by sampling from an adjusted probability distribution that is a function of a difference between a distribution generated by the verifying model 1002 and a distribution generated by the drafting model 106. The token-generating component 1016 also generates one extra token for the case in which all of the tokens in the batch have been accepted. The token-generating component 1016 uses the greedy approach to perform this task.

A prefix-updating component 1018 updates the set of tokens that will be sent to the drafting model 104 to include the tokens accepted by the acceptance-determining component 1004 and generated by the token-generating component 1016.

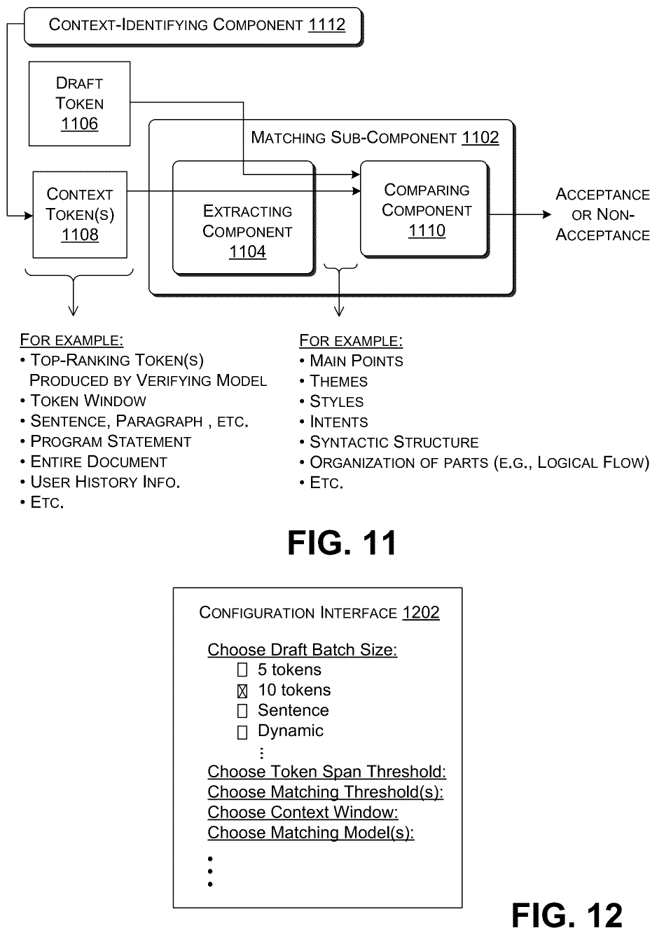

FIG. 11 shows an example of a matching sub-component 1102 used by the additional matching component 116 of FIG. 10 to perform the matching-based evaluation. An extracting component 1104 extracts one or more attributes from a draft token 1106 under consideration and one or more attributes from context tokens 1108. Collectively, the context tokens 1108 constitute context information. As previously described, the context information refers to any information that is used to gauge the acceptability of the draft token 1106. A comparing component 1110 generates an evaluation result that indicates whether or not to accept the draft token 1106 based on the extent to which the attribute(s) associated with the draft token 1106 match the attribute(s) associated with the context tokens 1108. As previously described, matching need not equate to equivalence in all cases.

Different types of context information are used in different types of applications. For example, some applications generate tokens based on auxiliary information provided by a source item, while other applications do not rely on auxiliary information. A text summarizing application is an example of the first type of program because it operates on a passage of text to be summarized. A creative writing application is an example of the second type of program because it generates a passage of text without the guidance of a preexisting text passage (although the weights of the language models do themselves reflect knowledge of previous text passages encountered during training). The previously generated text also constitutes context information with respect to the current draft token 1106 under consideration.

A context-identifying component 1112 chooses the context information to be fed into the matching sub-component 1102 based on the application that has been chosen and the configuration information. Examples of types of context information that may be chosen include: a) a set of top-ranking tokens identified by the verifying model 1002 for the draft token 1106; b) a window of tokens (such as a five-token window) in a larger body of context information in a source item; (c) a sentence, paragraph, etc. of a source item; (d) a program statement of a program; (e) an entire document; (f) plural previously-generated documents; (g) user history information, etc. As previously described, neighboring draft tokens and their ideal counterparts (identified by the verifying model 106) may be further considered as part of the context information that is relevant in evaluating the acceptability of any individual draft token.

Consider a text summarization application. For this case, the context-identifying component 1212 is instructed to choose context information that includes a window of words centered on a current point in a passage of text that is currently being summarized. In another example, the context-identifying component 1212 chooses context information defined by the bounds of the current sentence or paragraph being summarized. In another example, the context-identifying component 1212 chooses context information that encompasses an entire document being summarized. In any case, the context-identifying component 1112 can also weight the relevance of tokens in the context information based on their proximity from a current point being summarized, e.g., such that words that are closer to the current point are more heavily favored than words farther from the current point.

Consider next an automated agent application. For this case, the context-identifying component 1112 chooses context information that includes the top-ranking token(s) produced by the verifying model 106 for the draft token 1106 under consideration. The matching sub-component 1102 extracts the intent of the top-ranking token(s) and the intent of the draft token 1106. The matching sub-component 1102 uses this information to assess whether the intent of the draft token 1106 matches an ideal intent approximated by the top-ranking token(s) produced by the verifying model 106. The context-identifying component 1112 also chooses context information that encompasses a portion of a dialogue that has already been generated. The matching sub-component 1102 uses this information to determine whether the draft token 1106 under investigation coheres with the logical flow of a conversation.

The extracting component 1104 is configured to extract information from the context information and the draft token 1106 in different ways in different respective implementations. In some examples, the extracting component 1104 relies on a neural network of any kind, including a fully-connected feed-forward network (FFN), a convolutional neural network (CNN), a recurrent neural network (RNN), a transformer-based model, a selective state space model (such as a Mamba model), and so on, or any combinations thereof. For instance, the extracting component 1104 relies on a neural network of any type to map a sentence of the context information to a semantic embedding that describes a main concept or concepts conveyed by the sentence or the intent associated with the sentence. In another example, the extracting component 1104 relies on a sequence-based neural network to capture hidden state information regarding the organization of parts in a passage of text of the context information.

Alternatively, or in addition, the extracting component 1104 uses a statistical technique to extract information from the context information and the draft token 106. For example, the extracting component 1104 uses Latent Dirichlet Allocation (LDA) to extract topics from a passage of text of the context information. In another example, the extracting component 1104 uses a conditional random fields (CRF) model or hidden Markov model (HMM) to detect patterns in a passage of text of the context information.

Alternatively, or in addition, the extracting component 1104 uses a lexical/syntactical technique to extract information from the context information and the draft token 1106. For example, the extracting component 1104 identifies tokens in the context information, and determines whether these tokens are present in a pre-generated dictionary of key terms.

Different applications extract different types of information from the context information and the draft token 106. Examples of information extracted from the context information, for instance, include: a) main points of a text passage; b) themes of the text passage; c) styles of the text passage; d) intents expressed in the text passage; e) the categories of information conveyed by the text passage; f) the syntactical structure of the text passage; g) the organization of parts in the text passage, and so on.

The comparing component 1110 likewise relies on different techniques to compare information extracted from the draft token 1106 with information extracted from the context tokens 1108. For example, the comparing component 1110 relies on inner product, cosine similarity, or Euclidean distance to measure the similarity between two distributed vectors. The two vectors capture different topics, intents, etc. Alternatively, or in addition, the comparing component 1110 relies on KL divergence to measure the divergence between two probability distributions. Alternatively, or in addition, the comparing component 1110 relies on a lexical matching technique, such as edit distance, to measure the lexical similarity between two text strings, and so on.

FIG. 12 shows a configuration interface 1202 provided by the configuration component 1012 for collecting configuration information. In particular, this configuration interface 1212 includes graphical controls for selecting: a) the sub-component matching component(s) to be used; b) the draft batch size; c) any matching threshold parameter(s) (that determines when a draft token matches the context information); d) the token matching threshold parameter 1; e) the context window content and scope, and so on. For each of these categories, the configuration interface 1212 also allows a user to select a mode whereby a parameter is dynamically determined by the verifying model 106 based on one or more factors.

### D. The Language Model

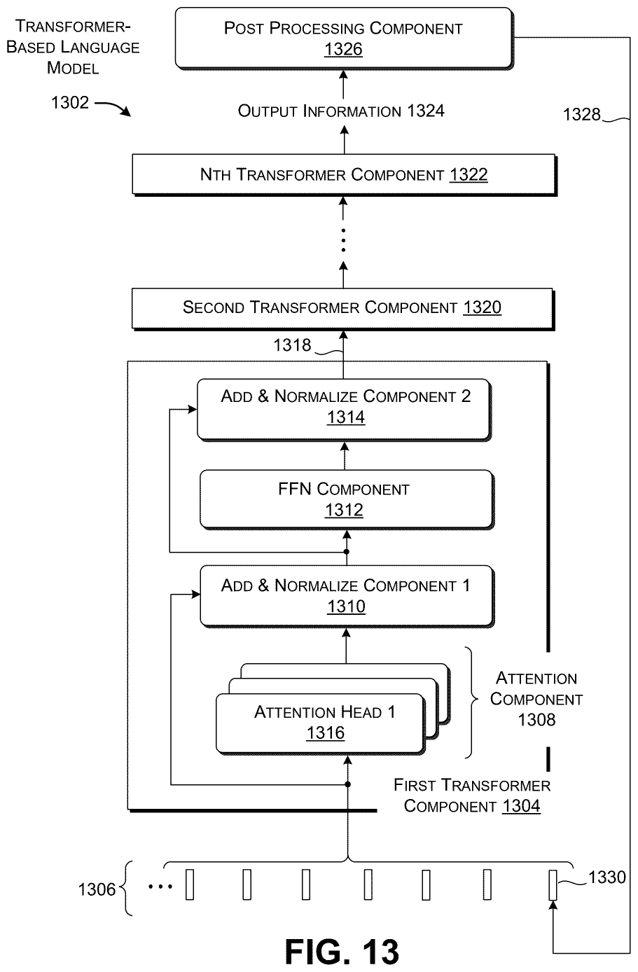

FIG. 13 shows a transformer-based language model (“language model”) 1302 for implementing parts of drafting model 104 and the verifying model 106. FIG. 13 specifically provides details regarding one way to implement the first transformer component 1304 of the language model 1302. Although not specifically illustrated, other transformer components of the language model 1302 have the same architecture and perform the same functions as the first transformer component 1304 (but are governed by separate sets of weights).

The language model 1302 commences its operation with the receipt of input information, such as a passage of text. The prompt includes a sequence of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. The principles set forth herein, however, are not limited to the processing of text information; in other examples, the language model 1302 operates on any of: audio information, image information, video information, sensor information, and so on, or any combination thereof.

Next, an embedding component (not shown) maps the sequence of tokens into respective token embeddings. The embedding component then adds position information (and, in some cases, segment information) to the respective token embeddings to produce position-supplemented embedding vectors 1306. The position information added to each token embedding describes the embedding vector's position in the sequence of token embeddings.

The first transformer component 1304 operates on the position-supplemented embedding vectors 1306. In some implementations, the first transformer component 1304 includes, in order, an attention component 1308, a first add-and-normalize component 1310, a feed-forward neural network (FFN) component 1312, and a second add-and-normalize component 1314.

The attention component 1308 determines how much emphasis should be placed on parts of input information when interpreting other parts of the input information. The attention component 1308 performs attention-based computations using the following equation:

$$Attention ( Q , K , V ) = ( \frac{{QK}^{T}}{\sqrt{{d}_{k}}} ) V . \qquad ( 1 )$$

The attention component 1308 produces query information Q by multiplying the position-supplemented embedding vectors 1306 by a query weighting matrix W^{Q}. Similarly, the attention component 1308 produces key information K and value information V by multiplying the position-supplemented embedding vectors 1306 by a key weighting matrix W^{K} and a value weighting matrix W^{V}, respectively. To execute Equation (1), the attention component 1308 takes the dot product of Q with the transpose of K, and then divides the dot product by a scaling factor \sqrt{d}, to produce a scaled result. The symbol d represents the dimensionality of Q and K. The attention component 1308 takes the Softmax (normalized exponential function) of the scaled result, and then multiplies the result of the Softmax operation by V, to produce attention output information. Background information regarding the general concept of attention is provided in Vaswani, et al., “Attention Is All You Need,” in 31st Conference on Neural Information Processing Systems (NIPS 2017), 2017, 11 pages.

Note that FIG. 13 shows that the attention component 1308 is composed of plural attention heads, including a representative attention head 1316. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1308 concatenates the output results of the attention component's separate attention heads, and then multiplies the results of this concatenation by another weight matrix W°.

The add-and-normalize component 1310 includes a residual connection that combines (e.g., sums) input information fed to the attention component 1308 with the output information generated by the attention component 1308. The add-and-normalize component 1310 then normalizes the output information generated by the residual connection, e.g., by layer-normalizing values in the output information based on the mean and standard deviation of those values, or by performing root-mean-squared normalization. The other add-and-normalize component 1314 performs the same functions as the first-mentioned add-and-normalize component 1310. The FFN component 1312 transforms input information to output information using a feed-forward neural network having any number of layers.

The first transformer component 1304 produces output information 1318. A series of other transformer components (1320, . . . , 1322) perform the same functions as the first transformer component 1304, each operating on output information produced by its immediately preceding transformer component. Each transformer component uses its own level-specific set of machine-trained weights. The final transformer component 1322 in the language model 1302 produces final output information 1324.

A post-processing component 1326 performs post-processing operations on the final output information 1324. For example, the post-processing component 1326 performs a machine-trained linear transformation on the final output information 1324, and processes the results of this transformation using a Softmax component (not shown). The language model 1302 uses the output of the post-processing component 1326 to predict the next token in the input sequence of tokens. In some applications, the language model 1302 performs this task using a greedy selection approach (e.g., by selecting the token having the highest probability), or by using the beam search algorithm (e.g., by traversing a tree that represents a search space of candidate next tokens). In contrast, the verifying model 106 maps the entire set of draft tokens to output logits in a single pass (that is, non-autoregressively).

In some implementations (e.g., for case of the drafting model in FIG. 7), the language model 1302 operates in an auto-regressive manner, as indicated by the loop 1328. To operate in this way, the language model 1302 appends a predicted token to the end of the sequence of input tokens, to provide an updated sequence of tokens. The predicted token leads to the production of a new position-supplemented vector 1330. In a next pass, the language model 1302 processes the updated sequence of position-supplemented vectors to generate a next predicted token. The language model 1302 repeats the above process until it generates a specified stop token.

The above-described implementation of the language model 1302 relies on a decoder-only architecture. Other implementations of the language model 1302 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component).

Other implementations of the language model 1302 use other kinds of machine-trained models besides, or in addition to, the particular transformer-based architecture shown in FIG. 13. The other machine-trained models include any of convolutional neural networks (CNNs), recurrent neural networks (RNNs), fully-connected feed-forward neural networks (FFNS), stable diffusion models, selective state space models (e.g., Mamba models), etc., or any combination thereof.

### E. Illustrative Processes

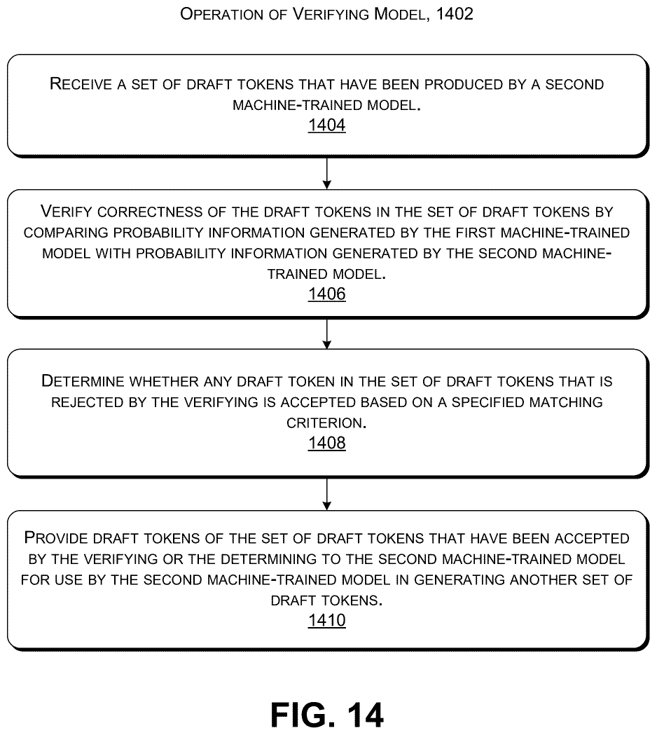

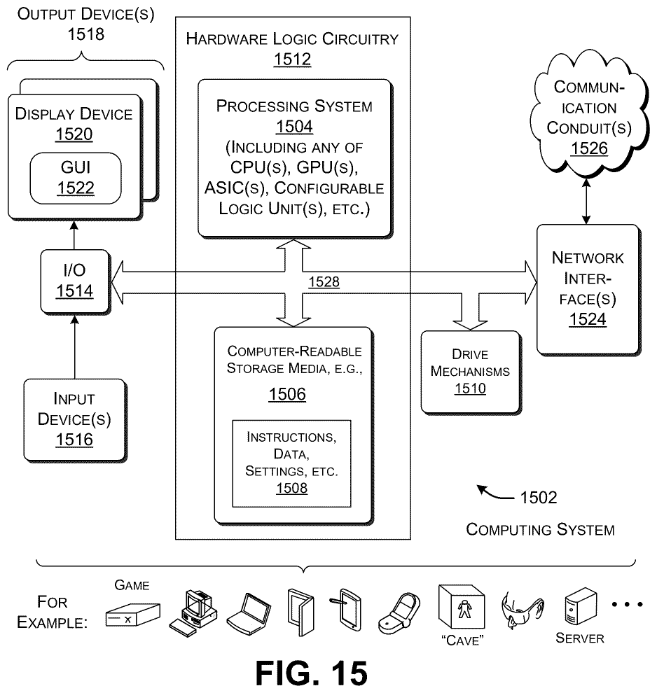

FIG. 14 shows an illustrative process 1402 that represents an overview of the operation of the speculative decoding system 102 of FIG. 1 from the perspective of a first machine-trained model (e.g., the verifying model 106). The process 1402 is expressed as a series of operations performed in a particular order. But the order of these operations is merely representative, and the operations are capable of being varied in other implementations. Further, any two or more operations described below are capable of being performed in a parallel manner. In one implementation, the blocks shown the process 1402 that pertain to processing-related functions are implemented by the computing equipment described in connection with FIG. 15.

More specifically, in block 1404, the first machine-trained model receives a set of draft tokens that have been produced by a second machine-trained model (e.g., the drafting model 104). In block 1406, the first machine-trained model verifies correctness of the draft tokens in the set of draft tokens by comparing probability information generated by the first machine-trained model with probability information generated by the second machine-trained model. In block 1408, the first machine-trained model determines whether any draft token in the set of draft tokens that is rejected by the verifying is accepted based on a specified matching criterion. In block 1410, the first machine-trained model provides draft tokens of the set of draft tokens that have been accepted by the verifying or the determining to the second machine-trained model for use by the second machine-trained model in generating another set of draft tokens.

### F. Illustrative Computing Devices

FIG. 15 shows a computing system 1502 that, in some implementations, is used to implement any aspect of the mechanisms set forth in the above-described figures. For instance, in some implementations, the type of computing system 1502 shown in FIG. 15 is used to implement any local computing device or any server shown in FIGS. 3 and 4. In all cases, the computing system 1502 represents a physical and tangible processing mechanism.

The computing system 1502 includes a processing system 1504 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1502 also includes computer-readable storage media 1506, corresponding to one or more computer-readable media hardware units. The computer-readable storage media 1506 retains any kind of information 1508, such as machine-readable instructions, settings, model weights, and/or other data. In some implementations, the computer-readable storage media 1506 includes one or more solid-state devices, one or more hard disks, one or more optical disks, etc. Any instance of the computer-readable storage media 1506 represents a fixed or removable unit of the computing system 1502. Further, any instance of the computer-readable storage media 1506 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1502 utilizes any instance of the computer-readable storage media 1506 in different ways. For example, in some implementations, any instance of the computer-readable storage media 1506 represents a hardware memory unit (such as random access memory (RAM)) for storing information during execution of a program by the computing system 1502, and/or a hardware storage unit (such as a hard disk) for retaining/archiving information on a more permanent basis. In the latter case, the computing system 1502 also includes one or more drive mechanisms 1510 (such as a hard drive mechanism) for storing and retrieving information from an instance of the computer-readable storage media 1506.

In some implementations, the computing system 1502 performs any of the functions described above when the processing system 1504 executes computer-readable instructions stored in any instance of the computer-readable storage media 1506. For instance, in some implementations, the computing system 1502 carries out computer-readable instructions to perform each block of the process 1402 described with reference to FIG. 14. FIG. 15 generally indicates that hardware logic circuitry 1512 includes any combination of the processing system 1504 and the computer-readable storage media 1506.

In addition, or alternatively, the processing system 1504 includes one or more other configurable logic units that perform operations using a collection of logic gates, such as field-programmable gate arrays (FPGAs), etc. In these implementations, the processing system 1504 effectively incorporates a storage device that stores computer-readable instructions, insofar as the configurable logic units are configured to execute the instructions and therefore embody or store these instructions.

In some cases (e.g., in the case in which the computing system 1502 represents a user computing device), the computing system 1502 also includes an input/output interface 1514 for receiving various inputs (via input devices 1516), and for providing various outputs (via output devices 1518). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1520 and an associated graphical user interface presentation (GUI) 1522. The display device 1520 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1502 also includes one or more network interfaces 1524 for exchanging data with other devices via one or more communication conduits 1526. One or more communication buses 1528 communicatively couple the above-described units together.

The communication conduit(s) 1526 is implemented in any manner, e.g., by a local area computer network, a wide area computer network (e.g., the Internet), point-to-point connections, or any combination thereof. The communication conduit(s) 1526 include any combination of hardwired links, wireless links, routers, gateway functionality, name servers, etc., governed by any protocol or combination of protocols.

FIG. 15 shows the computing system 1502 as being composed of a discrete collection of separate units. In some cases, the collection of units corresponds to discrete hardware units provided in a computing device chassis having any form factor. FIG. 15 shows illustrative form factors in its bottom portion. In other cases, the computing system 1502 includes a hardware logic unit that integrates the functions of two or more of the units shown in FIG. 15. For instance, in some implementations, the computing system 1502 includes a system on a chip (SoC or SOC), corresponding to an integrated circuit that combines the functions of two or more of the units shown in FIG. 15.

The following summary provides a set of illustrative examples of the technology set forth herein.

(A1) According one illustrative aspect, a method (e.g., the process 1402) is described for executing operations by a first machine-trained model (e.g., the verifying model 106). The method includes receiving (e.g., in block 1404) a set of draft tokens that have been produced by a second machine-trained model (e.g., the drafting model 104); verifying (e.g., in block 1406) correctness of the draft tokens in the set of draft tokens by comparing probability information generated by the first machine-trained model with probability information generated by the second machine-trained model; determining (e.g., in block 1408) whether any draft token in the set of draft tokens that is rejected by the verifying is accepted based on a specified matching criterion; and providing (e.g., in block 1410) draft tokens of the set of draft tokens that have been accepted by the verifying or the determining to the second machine-trained model for use by the second machine-trained model in generating another set of draft tokens.

(A2) According to illustrative implementations of A1, the first machine-trained model and the second machine-trained model are respective language models having different respective total numbers of parameters.

(A3) According to illustrative implementations of A1 or A2, the method further includes rejecting a particular draft token in the set of draft tokens that is rejected by both the verifying and the determining, and rejecting any draft tokens in the set of draft tokens that follows the particular draft token.

(A4) According to illustrative aspect of any of A1-A3, the method further includes rejecting a particular draft token in the set of draft tokens when: the particular draft token is rejected by the verifying; and the particular draft token is preceding by a prescribed number of draft tokens that have been accepted by the determining, the prescribed number being specified by a token span threshold parameter.

(A5) According to illustrative implementations of A4, the token span threshold parameter is determined by a configuration setting and remains fixed through the operations.

(A6) According to illustrative implementations of A4, the token span threshold parameter dynamically varies over the operations.

(A7) According to illustrative implementations of any of A1-A6, the method further includes invoking one or more matching components, from a set of available matching components, to perform the determining.

(A8) According to illustrative implementations of any of A1-A7, the determining includes: identifying a first attribute of context information; identifying a second attribute of a particular draft token; and determining whether the first attribute matches the second attribute.

(A9) According to illustrative implementations of A8, the context information includes, at least in part, a first-model token identified by the first machine-trained model as being correct.

(A10) According to illustrative implementations of A8 or A9, the operations include transforming a source item in a prescribed manner, and wherein the context information includes, at least in part, tokens of the source item.

(A11) According to illustrative implementations of any of A8-A10, the attribute of the context information identifies a semantic characteristic of the context information.

(A12) According to illustrative implementations of any of A8-A10, the first attribute of the context information includes any of: a topic expressed by the context information; a theme of the context information; a category expressed by the context information; a style of the context information; an intent expressed by the context information; a syntactical structure of the context information; and/or an organization of parts of the context information.

In yet another aspect, some implementations of the technology described herein include a computing system (e.g., the computing system 1502) that includes a processing system (e.g., the processing system 1504) having a processor. The computing system also includes a storage device (e.g., the computer-readable storage media 1506) for storing computer-readable instructions (e.g., the information 1508). The processing system executes the computer-readable instructions to perform any of the methods described herein (e.g., any individual method of the methods of A1-A12).

In yet another aspect, some implementations of the technology described herein include a computer-readable storage medium (e.g., the computer-readable storage media 1506) for storing computer-readable instructions (e.g., the information 1508). A processing system (e.g., the processing system 1504) executes the computer-readable instructions to perform any of the operations described herein (e.g., the operations in any individual method of the methods of A1-A12).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1512 of FIG. 15. The term “logic” likewise encompasses various physical and tangible mechanisms for performing a task. For instance, each processing-related operation illustrated in the process 1402 of FIG. 14 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for executing operations by a first machine-trained model, comprising:
receiving a set of draft tokens that have been produced by a second machine-trained model;
verifying correctness of the draft tokens in the set of draft tokens by comparing probability information generated by the first machine-trained model with probability information generated by the second machine-trained model;
determining whether any draft token in the set of draft tokens that is rejected by the verifying is accepted based on a specified matching criterion; and
providing draft tokens of the set of draft tokens that have been accepted by the verifying or the determining to the second machine-trained model for use by the second machine-trained model in generating another set of draft tokens.

2. The method of claim 1, wherein the first machine-trained model and the second machine-trained model are respective language models having different respective total numbers of parameters.

3. The method of claim 1, further comprising rejecting a particular draft token in the set of draft tokens that is rejected by both the verifying and the determining, and rejecting any draft tokens in the set of draft tokens that follows the particular draft token.

4. The method of claim 1, further comprising rejecting a particular draft token in the set of draft tokens when: the particular draft token is rejected by the verifying; and the particular draft token is preceding by a prescribed number of draft tokens that have been accepted by the determining, the prescribed number being specified by a token span threshold parameter.

5. The method of claim 4, wherein the token span threshold parameter is determined by a configuration setting and remains fixed through the operations.

6. The method of claim 4, wherein the token span threshold parameter dynamically varies over the operations.

7. The method of claim 1, further comprising invoking one or more matching components, from a set of available matching components, to perform the determining.

8. The method of claim 1, wherein the determining includes:
identifying a first attribute of context information;
identifying a second attribute of a particular draft token; and
determining whether the first attribute matches the second attribute.

9. The method of claim 8, wherein the context information includes, at least in part, a first-model token identified by the first machine-trained model as being correct.

10. The method of claim 8, wherein the operations include transforming a source item in a prescribed manner, and wherein the context information includes, at least in part, tokens of the source item.

11. The method of claim 8, wherein the attribute of the context information identifies a semantic characteristic of the context information.

12. The method of claim 8, wherein the first attribute of the context information includes any of:
a topic expressed by the context information;
a theme of the context information;
a category expressed by the context information;
a style of the context information;
an intent expressed by the context information;
a syntactical structure of the context information; and/or
an organization of parts of the context information.

13. A computing system for executing operations by a first machine-trained model, comprising:
an instruction data store for storing computer-readable instructions; and
a processing system for executing the computer-readable instructions in the data store, to perform operations including:
receiving a set of draft tokens that have been produced by a second machine-trained model;
verifying correctness of the draft tokens in the set of draft tokens by comparing probability information generated by the first machine-trained model with probability information generated by the second machine-trained model;
determining whether any draft token in the set of draft tokens that is rejected by the verifying matches an attribute of identified context information; and
providing draft tokens of the set of draft tokens that have been accepted by the verifying or the determining to the second machine-trained model for use by the second machine-trained model in generating another set of draft tokens.

14. The computing system of claim 13, further comprising rejecting a particular draft token in the set of draft tokens when: the particular draft token is rejected by the verifying; and the particular draft token is preceding by a prescribed number of draft tokens that have been accepted by the determining.

15. The computing system of claim 13, wherein the attribute of the context information includes any of:
a topic expressed by the context information;
a theme of the context information;
a category expressed by the context information;
a style of the context information;
an intent expressed by the context information;
a syntactic structure of the context information; and/or
an organization of parts of the context information.

16. The computing system of claim 13,
wherein the operations are performed to summarize a passage of text,
wherein the context information includes a portion of the passage of text, and
wherein the determining accepts a particular draft token if the particular draft token has semantic content that matches a same key point that is expressed in the portion of the passage of text.

17. The computing system of claim 13,
wherein the operations are performed to produce a response in a dialogue,
wherein the context information expresses a portion of the dialogue and a first-model token that is identified by the first machine-trained model as being correct, and
wherein the determining accepts a particular draft token if the particular draft token has a same intent as the first-model token and coheres with a logical flow of the dialogue expressed in the portion.

18. A computer-readable storage medium for storing computer-readable instructions, a processing system executing the computer-readable instructions to perform operations using a first machine-trained model, the operations comprising:
receiving a set of draft tokens that have been produced by a second machine-trained model;
verifying correctness of the draft tokens in the set of draft tokens by comparing probability information generated by the first machine-trained model with probability information generated by the second machine-trained model;
determining whether any draft token in the set of draft tokens that is rejected by the verifying is accepted based on a specified matching criterion,
the determining being performed for a particular draft token in the set of tokens when the particular draft token is not preceded by a prescribed number of other draft tokens that have been accepted by the determining; and
providing any draft token in the set of draft tokens that have been accepted by the verifying or the determining to the second machine-trained model.

19. The computer-readable storage medium of claim 18, wherein the determining includes:
identifying a first attribute of context information;
identifying a second attribute of a draft token; and
determining whether the first attribute matches the second attribute.

20. The computer-readable storage medium of claim 19, wherein the attribute of the context information includes any of:
a topic expressed by the context information;
a theme of the context information;
a category expressed by the context information;
a style of the context information;
an intent expressed by the context information;
a syntactic structure of the context information; and/or
an organization of parts of the context information.
